(19) United States
(12) Patent Application Publication
(10) Pub. No.: US 2011/0083954 A1
(43) Pub. Date: Apr. 14, 2011

(54) METHOD AND APPARATUS FOR PRODUCING CARBOHYDRATES AND OXYGEN USING CIRCULARLY POLARIZED ROTATING ELECTROMAGNETIC WAVE

(76) Inventors: Hung Kuk Oh, Gyeonggi-do (KR); Yo Han Oh, Gyeonggi-Do (KR); Jeung Hyun Oh, Gyeonggi-Do (KR)

(21) Appl. No.: 12/996,584

(22) PCT Filed: Jun. 4, 2009
(86) PCT No.: PCT/KR09/02998

§ 371 Date: Dec. 6, 2010

(30) Foreign Application Priority Data
Jun. 4, 2008 (KR) 10-2008-0052726

(51) Int. Cl. B01J 19/12; B01J 19/08

(52) U.S. Cl. 204/155; 422/186.04

(57) ABSTRACT

Provided are a method and apparatus for producing carbohydrates and oxygen from water and carbon dioxide, wherein the method comprises irradiating a circularly polarized rotating electromagnetic wave to a reactant comprising water and carbon dioxide to produce carbohydrates and oxygen.

### TECHNICAL FIELD

The present invention relates to a method and apparatus for producing carbohydrates and oxygen from water and carbon dioxides, wherein the method includes irradiating a circularly polarized rotating electromagnetic wave to a reactant including water and carbon dioxide to produce carbohydrates and oxygen.

### BACKGROUND ART

The present invention provides a method of producing carbohydrates and oxygen from water and carbon dioxide, wherein the method includes irradiating a circularly polarized rotating electromagnetic wave to a reactant including water and carbon dioxide to produce carbohydrates and oxygen.

Electromagnetic waves are synthetic waves produced by an electric field and a magnetic field, which are generated by electricity. Electromagnetic waves are generated by electric appliances or devices which are widely used in our periphery. In an electromagnetic wave, an electric field extends vertically in space and is represented in units of volts per meter (V/m), and a magnetic field extends horizontally in space and is represented in units of miligauss (mG).

Electromagnetic waves are classified into a home-use power frequency of 50 Hz or 60 Hz, an extremely low frequency of 0 to 1 kHz, a low frequency of 1 to 500 kHz, a communication frequency of 500 kHz to 300 MHz, and a microwave range of 300 MHz to 300 GHz, according to frequency, that is, the number of oscillations per second. Infrared rays, visible rays, ultraviolet rays, X-rays, and gamma rays have increasingly high frequencies. When the human body is exposed to extremely low frequency and low frequency electromagnetic radiation which is generated by an electric field and a magnetic field for a long time, the temperature of the human body is changed, and thus a bio-rhythm is unbalanced, and, accordingly, may result in a disease. Also, according to the results of research, the low and extremely low frequency radiation may reduce the sperm count of men, and cause an irregular physiological phenomenon and the birth of a deformed child for women. Also, in severe cases, brain cancer can result. Accordingly, the WHO (World Health Organization) has investigated the harmfulness of electromagnetic waves and provoked people's attention.

However, research into the harmfulness of electromagnetic waves is not concluded, and it is recommended to stay away from an electromagnetic wave generation source.

Electromagnetic waves are classified into gamma rays, X-rays, ultraviolet rays, visible rays, radio waves such as ultra-sonic waves, high frequency waves, low frequency waves, and extremely low frequency waves, in order of decreasing frequency. Here, radio waves have a frequency of 3,000 GHz, that is, three trillion oscillations per second, or less. Radio waves are used for various purposes and are essential for our ordinary lives.

Electric energy can be defined as the energy of electrons flowing through conductive wires. According to recent research, it has been disclosed that electric energy is generated by circularly polarized rotating electromagnetic waves and the oscillation of electrons.

The circularly polarized rotating electromagnetic wave can be used to analyze electric energy using a different concept from existing other electric energy analysis methods. The principle of circularly polarized rotating electromagnetic wave generation is as follows. Since low frequency electromagnetic waves have minute kinetic energy, they cannot be detected by humans. When electromagnetic radiation collides with matter in free space, the matter may generate visible rays to release the energy obtained from the electromagnetic radiation. Aerial nutritional particles receive electromagnetic waves at a resonant frequency and enter an excited state, and then produce visible rays to return to a base state thereafter. When colored light of various wavelengths combines and travels along a plane, a reflective wavelength and an absorbent wavelength reflected and absorbed by particles in air intersect each other. Color waves are produced using a principle of wavelength energy generated when energy emits whenever light moves according to the kind of visible rays and collides with particles in a free space. The wavelength energy is produced to mitigate a tension of general nutritional components or aerial particles in the air, and is transferred through an oscillation process by a resonant phenomenon in the air. When color light having different wavelengths gets joined together and irradiated on a plane, a reflective wavelength and an absorbent wavelength cross-sect together. In this case, a circularly polarized rotating electromagnetic wave with a long wavelength, such as an ultrasonic wave, produces dry wave energy and neutralized wave energy.

The circularly polarized rotating electromagnetic waves are electromagnetic waves which perform a certain rotational movement. The circularly polarized rotating electromagnetic waves are produced by, for example, crystallization π-coupling when atoms are coupled. The crystallization π-coupling causes a thermal ray to change to a circularly polarized rotating electromagnetic wave. Crystallization π-coupling materials are found in, for example, alum rock or yellow soil, and it is known that these materials emit electromagnetic waves helpful to the human body. Thus, crystallization π-coupling materials are used in bathrooms, beds, alum water pipes, clothes, and architecture materials. For example, clothes having many crystallization π-coupling materials change harmful circularly polarized rotating electromagnetic waves contacting the surface of the clothes into beneficial circularly polarized rotating electromagnetic waves, thereby removing the harmfulness of the circularly polarized rotating electromagnetic waves.

Also, the crystallization π-coupling can convert a strong visible ray into a circularly polarized rotating electromagnetic wave, thus producing much absorption energy. The absorption energy is used to cure cancer and delay the growth of cancer cells. The circularly polarized rotating electromagnetic waves which are produced by the crystallization π-coupling can sterilize harmful microbes, and thus can be applied to industries in which sterilization is necessary, such as water pipe fabrication. Also, the circularly polarized rotating electromagnetic waves which are produced by the crystallization π-coupling can be applied to soup, detergent, soles of shoes, or cosmetics. It is regarded that this is because the crystallization π-coupling converts heat emitted from the human body into circularly polarized rotating electromagnetic waves beneficial to the human body. The circularly polarized rotating electromagnetic waves have been applied to oriental and other medical field or medicines. Since circularly polarized rotating electromagnetic waves can be beneficial to the human body, they are regarded as a source of bio-energy or spirits which in oriental medical science.

In a conventional method of measuring circularly polarized rotating electromagnetic waves, infrared rays (heat rays) derived from the circularly polarized rotating electromagnetic wave are measured to thus measure the rate of generation of circularly polarized rotating electromagnetic waves from heat rays, or to measure a sterilization capability.

Examples of using circularly polarized rotating electromagnetic waves are presented in: Hung Kuk Oh, “π-ray physics”, 2001, The Ajou University Press, ISBN. NO. 89-86161-14-1-93420.

Also, an O-ring test (fingers force tester), a quantum resonance spectrometer, meridian, and a quantum fractal auto focusing analyser are disclosed in Hung Kuk Oh, “Some comments on implosion and Brown gas”, J. Mater. Process. Technol., 95(1999), 8-9; Hung Kuk Oh, “Vortex of electrons π-bonding of atoms and superconduction”, J. Mater. Process. Technol., 74(1-3)(1998) 126-130; and Hung Kuk Oh, “Some observations on the cavity of creation for cold fusion and the generation of heat”, J. Mater. Process. Technol., 94(1999) 60-65).

Also, NMR is disclosed in Hung Kuk Oh, “Conventional metallic bonding and three-dimensional crystallizing π-bonding”, J. Mater. Process. Technol., 94(1999) 60-65; and W. J. Gullick et al, “Three dimensional structure of the transmembrane region of the proto-oncogenic and oncogenic forms of the neu protein”, EMBO J. 11(1)1992, 43-48.

However, the above-described conventional methods have problems in that measured values of the circularly polarized rotating electromagnetic wave may not be reproduced or measuring instruments are somewhat complicated. In addition, the reason why the evaluation values are not reproducible has not been scientifically examined. The inventor of the present invention conducted research into solving this problem and registered KR No. 10-0432982, KR No. 10-0631869, and U.S. Pat. No. 7,286,228. According to the invention disclosed in KR No. 10-0432982, a circularly polarized rotating electromagnetic wave surrounding a material is induced to be emitted. In this case, the emitted circularly polarized rotating electromagnetic wave is changed into a straight electromagnetic wave and the straight electromagnetic wave is emitted. When the size of the straight electromagnetic wave is measured, reproducible data with respect to the circularly polarized rotating electromagnetic wave can be obtained. According to the invention disclosed in KR No. 10-0631869 or U.S. Pat. No. 7,286,228, based on a phenomenon in which, when circularly polarized rotating electromagnetic waves meet each other in an electromagnetic field, the intensity of energy is amplified or reduced, particular properties of a circularly polarized rotating electromagnetic wave are simply and effectively measured by measuring properties of naturally generated circularly polarized rotating electromagnetic waves.

Properties of a circularly polarized rotating electromagnetic wave can be classified into a left-circularly polarized rotating positive property, a left-circularly polarized rotating negative property, a right-circularly polarized rotating positive property and a right-circularly polarized rotating negative property. Theses properties can be differentiated using a measurement method including an operation that will be described here below.

Whether a circularly polarized rotating electromagnetic wave is positive or negative can be identified using a measurement method disclosed in KR No. 10-0432982. That is, a material of which a property of a circularly polarized rotating electromagnetic wave is to be measured is placed in water and then left to sit for a predetermined time period so that the water absorbs circularly polarized rotating electromagnetic waves emitted from the material. The water that has absorbed the circularly polarized rotating electromagnetic waves is interposed between electrodes to which an appropriate voltage is applied and then a discharging operation is performed thereon. In this case, a discharged light is photographed and a luminous intensity is expressed by multiple pixels, and a relative circularly polarized rotating electromagnetic wave of water is measured using a discharge device. Thus, properties of a circularly polarized rotating electromagnetic wave of a material can be identified by indirect measurement. The time period for which the material is left to sit in the water may not be limited, and may be about 3 hours. The water that has absorbed the circularly polarized rotating electromagnetic waves is interposed between electrodes to which an appropriate voltage is applied and then discharged. The discharged light is photographed and a luminous intensity is expressed by a multiple of pixel. In this regard, the voltage applied for the discharging may be in the range of 500 to 2,000 V. However, the voltage range is not limited thereto. The discharging may be performed using a conventionally available discharge device. For example, a gas discharge visualization (GDV) device may be used. When a GDV device is used, the discharging may be performed in an environment in which water is located at an anode of the GDV, and air or gas fills a space between the water and a cathode. Specifically, a water sample is located at a portion of an anode and a space between the water sample and a cathode is filled with an air layer or a gaseous layer, so that a circularly polarized rotating electromagnetic wave in the water sample is transferred to the air layer or the gaseous layer and as a result, the discharge state of the water sample is changed. The obtained data can be represented using multiple pixels that affect a luminous intensity of a measurement system used in the measurement method. With reference to the value of a control group, a positive (+) value of a circularly polarized rotating electromagnetic wave means that the circularly polarized rotating electromagnetic wave energy is emitted; and a negative (−) value of a circularly polarized rotating electromagnetic wave means the circularly polarized rotating electromagnetic wave energy is absorbed. That is, the higher the value of the circularly polarized rotating electromagnetic wave is compared to the value of the control group, the higher the discharge rate of the circularly polarized rotating electromagnetic wave is; the lower the value of the circularly polarized rotating electromagnetic wave is compared to the value of the control group, the higher the energy absorption rate is. By using the measurement method described above, materials emitting positive and negative circularly polarized rotating electromagnetic waves can be differentiated from each other.

Whether a circularly polarized rotating electromagnetic wave has a left-circularly polarized rotating property or a right- circularly polarized rotating property can be identified using a measurement method disclosed in KR No. 10-0631869 or U.S. Pat. No. 7,286,228. The disclosed measurement method includes (1) forming a magnetic field using a permanent magnet or an electromagnet; (2) irradiating a circularly polarized rotating electromagnetic wave, which is emitted from a material of which a property of a circularly polarized rotating electromagnetic wave is to be measured, into the magnetic field; (3) measuring a change of a current by referring to a change in the magnetic field; and (4) determining whether the circularly polarized rotating electromagnetic wave, which is emitted from the material of which a property of a circularly polarized rotating electromagnetic wave is to be measured, has a left-circularly polarized rotating property or a right-circularly polarized rotating property, according to the change of the current measured by referring to the change in the magnetic field, based on a phenomenon in which a circularly polarized rotating electromagnetic wave having a left-circularly polarized rotating property proceeds in a direction from an S pole to an N pole, and a circularly polarized rotating electromagnetic wave having a right-circularly polarized rotating property proceeds in a direction from an N pole to an S pole. To determine whether the emitted circularly polarized rotating electromagnetic wave has a right-circularly polarized rotating property or a left-circularly polarized rotating property, stimulus sites of S and N poles, which are dependent upon a magnetic field and increase or decrease in a magnetic field formed by a permanent magnet or an electromagnet, are taken into consideration. By referring to the phenomenon in which a circularly polarized rotating electromagnetic wave having a left-circularly polarized rotating property proceeds in a direction from an S pole to an N pole, and in which a circularly polarized rotating electromagnetic wave having a right-circularly polarized rotating property proceeds in a direction from an N pole to an S pole, it can be determined whether a measurement material emits a circularly polarized rotating electromagnetic wave having a right-circularly polarized rotating direction or a left-circularly polarized rotating direction.

Furthermore, the inventor of the present invention has continued to conduct research into applications of a circularly polarized rotating electromagnetic wave based on the method of measuring properties of the circularly polarized rotating electromagnetic wave, and found that carbohydrates and oxygen can be produced by irradiating a circularly polarized rotating electromagnetic wave to a reactant including water and carbon dioxide.

### DISCLOSURE OF INVENTION

### Technical Problem

The present invention provides a method of producing carbohydrates and oxygen from water and carbon dioxide by using a circularly polarized rotating electromagnetic wave. The present invention also provides an apparatus for producing carbohydrates and oxygen from water and carbon dioxide by using a circularly polarized rotating electromagnetic wave.

### Technical Solution

According to an aspect of the present invention, there is provided a method of producing carbohydrates and oxygen from water and carbon dioxide, wherein the method includes irradiating a circularly polarized rotating electromagnetic wave to a reactant including water and carbon dioxide to produce carbohydrates and oxygen.

In the method according to the present invention, the reactant may include water and air including carbon dioxide. The water may be distilled water, or water containing impurities such as a tap water including mineral components dissolved therein. The carbon dioxide may be included in the air.

In the method according to the present invention, although the circularly polarized rotating electromagnetic wave may have various properties of circularly polarized rotating electromagnetic waves as described above, for example, the circularly polarized rotating electromagnetic wave may be a positive left-circularly polarized infrared light circularly polarized rotating electromagnetic wave. The infrared ray may be, but is not limited to, a far infrared ray having a wavelength equal to or greater than 25 μm. The circularly polarizing means that electric(or magnetic) field is circular-oscillating in a perpendicular plane to the waves advancing direction. An observer, when follows the advancing wave, can say leftwise or rightwise whether he sees the leftwise or rightwise rotating circular oscillation. When a linear polarized light is irradiated to a main surface of a quarter-wave plate at an angle of 45° light that passes therethrough becomes circularly polarized light.

In the method according to the present invention, the irradiation of the circularly polarized rotating electromagnetic wave is embodied by irradiating light to a material that emits a circularly polarized rotating electromagnetic wave. Examples of the material that emits a circularly polarized rotating electromagnetic wave may include ceramics that are known to emit many circularly polarized rotating electromagnetic waves in their natural state, elvan, tourmaline, Chuncheon jade, amethyst, copper, iron, aluminum, silver, and plastics. However, the material that emits a circularly polarized rotating electromagnetic wave is not limited thereto. The material that emits a circularly polarized rotating electromagnetic wave may be selected from the group consisting of a material or a material with another thin film material's coating having a trigonal prism shape, a square pillar shape, a column shape, a spherical shape, a tetrahedral shape, and a pyramidal shape. Examples of the light include a visible light ray, an infrared ray, a ray having a millimeter wave, a ray having a micro wave, and a ray having a radio wave. The light may be generated from a light source.

In the method according to the present invention, the irradiation may be performed at a temperature of 0° C. to 100° C. at a pressure of 0.1 atm to 10 atm.

In the method according to the present invention, the carbohydrates may be glucose or starch.

In the method according to the present invention, light is irradiated in a vessel containing a material that emits a circularly polarized rotating electromagnetic wave. The material that emits a circularly polarized rotating electromagnetic wave may be a material selected from the group consisting of ceramics that are known to emit many circularly polarized rotating electromagnetic waves in their natural state, elvan, tourmaline, Chuncheon jade, amethyst, copper, iron, aluminum, silver, plastics and a material with another thin film material's coating. The plastics include for example, polyethylene, PVC, polypropylene, saran, polystylene, polytetrafluoroethylene, PMMA, linear polyester, fluorinated ethylenepropylene, and polyhexamethylene adipamide. The colors of the plastics include for example, white, green, black, gray, yellow, brown, blue, and red. However, the material that emits a circularly polarized rotating electromagnetic wave is not limited thereto and may also be other materials.

According to another aspect of the present invention, there is provided an apparatus for producing carbohydrates and oxygen from water and carbon dioxide, wherein the apparatus includes a reaction vessel and a circularly polarized rotating electromagnetic wave generation unit for supplying a circularly polarized rotating electromagnetic wave to the reaction vessel.

In regard to the apparatus according to the present invention, the circularly polarized rotating electromagnetic wave generation unit includes a material that emits a circularly polarized rotating electromagnetic wave and a light source that supplies light to the material. The material that emits a circularly polarized rotating electromagnetic wave may be selected from the group consisting of ceramics that are known to emit many circularly polarized rotating electromagnetic waves in their natural state, elvan, tourmaline, Chuncheon jade, amethyst, copper, iron, and plastics. However, the material that emits a circularly polarized rotating electromagnetic wave is not limited thereto and may also be other materials. The light source may be an incandescent lamp or a fluorescent lamp, but is not limited thereto.

In regard to the apparatus according to the present invention, the circularly polarized rotating electromagnetic wave may have various properties. For example, the circularly polarized rotating electromagnetic wave may be a positive infrared light left-circularly polarized rotating electromagnetic wave.

In regard to the apparatus according to the present invention, the reaction vessel may contain water and carbon dioxide.

In regard to the apparatus according to the present invention, the reaction vessel may contain the material that emits a circularly polarized rotating electromagnetic wave.

### ADVANTAGEOUS EFFECTS

As described above, by using a method and apparatus for producing carbohydrates and oxygen by irradiating a circularly polarized rotating electromagnetic wave to a reactant including water and carbon dioxide, production of hydrocarborates that is a necessary nutrient element, absorption of carbon dioxide from carbon emissions sources, and production of oxygen can be performed at an industrial-scale.

### BRIEF DESCRIPTION OF DRAWINGS

FIG. 1 shows an image of a reaction vessel containing tap water before an experiment is performed according to an embodiment of the present invention;

FIG. 2 shows an image of the reaction vessel of FIG. 1 after an experiment is performed according to an embodiment of the present invention, wherein the reaction vessel contains a reaction product; and

FIG. 3 shows an image showing a result obtained by reacting the reaction product of FIG. 2 with a solution for component analysis.

### BEST MODE FOR CARRYING OUT THE INVENTION

Hereinafter, the present invention will now be described more fully with reference to the accompanying drawings. The following examples are for illustrative purposes only and are not intended to limit the scope of the invention

### Example 1

A sample that emits a positive infrared light left-circularly polarized rotating electromagnetic wave was selected using a method of measuring a property of a circularly polarized rotating electromagnetic wave, wherein the sample included a ceramic.

Tap water having a volume of 100 cm³ was loaded into a sample cup (transparent plastic cup), and a sample having a volume of 30 cm³, of which a circularly polarized rotating electromagnetic wave is to be measured, was loaded thereinto, thereby forming a total volume of 130 cm³. In this case, the sample included a ceramic. For a control group, only 100 cm³ of tap water was loaded into a sample cup. The prepared sample cups of the experimental group and control group were left to sit for a selected time period. A volume of 20 mm² of the obtained sample results was loaded into a GDV device by using a syringe having a nozzle diameter of 2 mm, and then interposed between electrodes to which an appropriate voltage (1,000 V: phase II from among phases I, II, III, and IV of the GDV device) had been applied. Then, discharging occurred and the emitted discharge light was photographed. The luminous intensity of the discharged light was represented by multiple pixels. Among the samples results, only samples corresponding to sample results having a positive (+) value with reference to the control group were selected. In addition, among the selected samples, only samples that emitted a left-circularly polarized rotating electromagnetic wave when an apparatus for measuring a circularly polarized rotating electromagnetic wave by using a magnetic field disclosed in KR No. 10-0631869 was brought into contact therewith, were selected. The formation of the left-circularly polarized rotating electromagnetic wave means that a current was increased due to a change in a magnetic field. Since methods of identifying an circularly polarized infrared light are obvious to one of ordinary skill in the art, detailed descriptions thereof will not be described therein.

### Example 2

White material and bubbles were formed from water and carbon dioxide by using a material that emits a circularly polarized rotating electromagnetic wave and a light source.

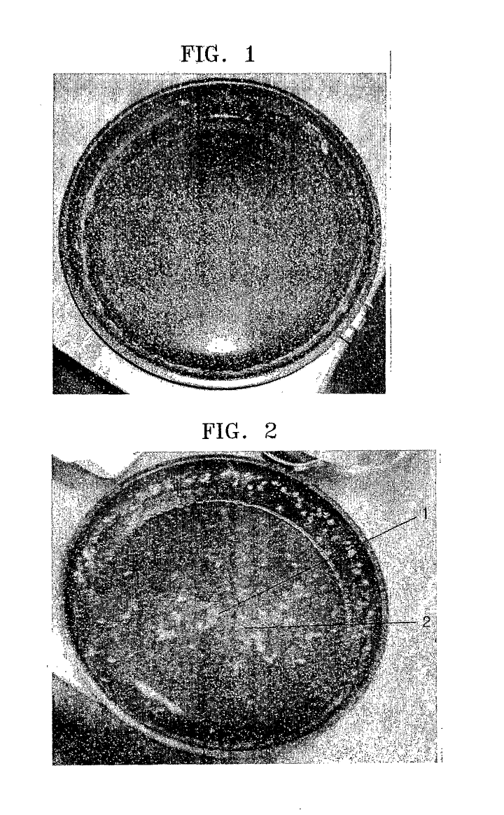

The samples selected in Example 1 were placed in a lidless reaction vessel containing tap water (FIG. 1), and then exposed to an incandescence lamp for 10 hours. Therefore, as shown in FIG. 2, white material 1 and bubbles 2 were formed on the surface of the tap water.

### Example 3

### Identification of Formed White Material and Bubbles

To identify components that form the white material formed in Example 2, both a Fehling s solution for detecting glucose and an iodine-potassium iodide solution for detecting starch were reacted with the white material and it was identified whether color changed. To identify components that form the bubbles formed in Example 2, a frame reached with the bubbles.

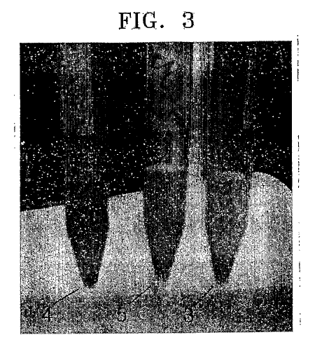

As shown in FIG. 3, when compared to a control group 3 in which the white material was not reacted with any material, when reacted with the Fehling s solution, a blue precipitate 4 was formed from the white material; and when reacted with the iodine-potassium iodide solution, the white material was changed into a blue material 5. In addition, when the formed bubbles were captured and then reacted with the frame, the frame burnt well. Based on the experimental results, it was identified that the white material was a carbohydrate including glucose or starch, and the generated bubbles contained oxygen.

### Example 4

### Replication of Examples 1 through 3

The same experiments were repeatedly performed in the same manner as in Examples 1 to 3, except that in Example 1, the tap water was replaced with distilled water; in Example 1, the ceramic was replaced with elvan, tourmaline, Chuncheon jade, amethyst, copper, iron, aluminum, silver, plastics and a material with another thin film material's coating; and in Example 2, the incandescent lamp was replaced with a fluorescent lamp and other sources. The resultant sample products were the same as those obtained in Examples 1 to 3.

1. A method of producing carbohydrates and oxygen from water and carbon dioxide, wherein the method comprises irradiating a circularly polarized rotating electromagnetic wave to a reactant comprising water and carbon dioxide to produce carbohydrates and oxygen.

2. The method of claim 1, wherein the reactant comprises water and air comprising carbon dioxide.

3. The method of claim 1, wherein the circularly polarized rotating electromagnetic wave is one or more selected from the group comprising of a positive left circularly polarized rotating electromagnetic wave, a negative left circularly polarized rotating electromagnetic wave, a positive right circularly polarized rotating electromagnetic wave, and a negative right circularly polarized rotating electromagnetic wave.

4. The method of claim 1, wherein the irradiating of the circularly polarized rotating electromagnetic wave is performed by irradiating light to a material that emits a circularly polarized rotating electromagnetic wave.

5. The method of claim 4, wherein the material that emits a circularly polarized rotating electromagnetic wave is selected from the group consisting of ceramics, elvan, tourmaline, Chuncheon jade, amethyst, copper, iron, aluminum, silver, plastics and a material with another thin film material s coating.

6. The method of claim 5, wherein the plastics is selected from the group consisting of polyethylene, PVC, polypropylene, saran, polystylene, polytetrafluoroethylene, PMMA, linear polyester, fluorinated ethylenepropylene, and polyhexamethylene adipamide.

7. The method of claim 6, wherein the color of the plastics is selected from the group consisting of white, green, black, gray, yellow, brown, blue, and red.

8. The method of claim 4, wherein the material that emits a circularly polarized rotating electromagnetic wave is selected from the group consisting of a material having a trigonal prism shape, a material having a square pillar shape, a material having a column shape, a material having a spherical shape, and a material having a pyramidal shape.

9. The method of claim 4, wherein the light is selected from the group consisting of a visible light ray, an infrared ray, a ray having a millimeter wave, a ray having a micro wave, and a ray having a radio wave.

10. The method of claim 4, wherein the light is generated by one or more selected from the group comprising of a fluorescent lamp, an incandescent lamp, microwave source, and radiowave source.

11. The method of claim 1, wherein the irradiation is performed at a temperature in the range of 0° C. to 100° C.

12. The method of claim 1, wherein the irradiation is performed at a pressure in the range of 0.1 atm to 10 atm.

13. The method of claim 1, wherein the carbohydrates comprise glucose or starch.

14. The method of claim 1, wherein light is irradiated in a reaction vessel containing a material or a material with another thin film material's coating that emits a circularly polarized rotating electromagnetic wave.

15. An apparatus for producing carbohydrates and oxygen from water and carbon dioxide, the apparatus comprising:
a reaction vessel; and
a circularly polarized rotating electromagnetic wave generation unit for supplying a circularly polarized rotating electromagnetic wave to the reaction vessel.

16. The apparatus of claim 15, wherein the circularly polarized rotating electromagnetic wave generation unit comprises:
a material or a material with another thin film material's coating that emits a circularly polarized rotating electromagnetic wave; and
a light source for supplying light to the material.

17. The apparatus of claim 16, wherein the material that emits a circularly polarized rotating electromagnetic wave is selected from the group consisting of ceramics, elvan, tourmaline, Chuncheon jade, amethyst, copper, iron, aluminum, silver, plastics and a material with another thin film material's coating.

18. The apparatus of claim 17, wherein the plastics is selected from the group consisting of polyethylene, PVC, polypropylene, saran, polystylene, polytetrafluoroethylene, PMMA, linear polyester, fluorinated ethylenepropylene, and polyhexamethylene adipamide.

19. The apparatus of claim 18, wherein the color of the plastics is selected from the group consisting of white, green, black, gray, yellow, brown, blue, and red.

20. The apparatus of claim 16, wherein the material that emits a circularly polarized rotating electromagnetic wave is selected from the group consisting of a material or a material with another thin film material's coating having a trigonal prism shape, a material having a square pillar shape, a material having a column shape, a material having a spherical shape, and a material having a pyramidal shape.

21. The apparatus of claim 16, wherein the light is selected from the group consisting of a visible light ray, an infrared ray, a ray having a millimeter wave, a ray having a micro wave, and a ray having a radio wave.

22. The apparatus of claim 16, wherein the light is generated by one or more selected from the group comprising of a fluorescent lamp, an incandescent lamp, microwave source, and radiowave source.

23. The apparatus of claim 15, wherein the circularly polarized rotating electromagnetic wave is one or more selected from the group comprising of a positive left circularly polarized rotating electromagnetic wave, a negative left circularly polarized rotating electromagnetic wave, a positive right circularly polarized rotating electromagnetic wave, and a negative right circularly polarized rotating electromagnetic wave.

24. The apparatus of claim 15, wherein the reaction vessel contains water and carbon dioxide.

25. The apparatus of claim 15, wherein the reaction vessel contains a material or a material with another thin film material's coating that emits a circularly polarized rotating electromagnetic wave.
